(19) United States
(12) Patent Application Publication
(10) Pub. No.: US 2015/0193029 A1
(43) Pub. Date: Jul. 9, 2015

(54) WIRELESS TOUCHSCREEN DEVICE FOR DESKTOP COMPUTER

(71) Applicant: Cory Dohm, Ledyard, CT (US)

(72) Inventor: Cory Dohm, Ledyard, CT (US)

(21) Appl. No.: 14/146,926

(22) Filed: Jan. 3, 2014

(51) Int. Cl. G06F 3/041

(52) U.S. Cl. CPC G06F 3/041

(57) ABSTRACT

A wireless touchscreen device for use with a desktop computer comprising a housing, where the housing includes an edging; a touchscreen on a front face the housing, where the touchscreen is surrounded by the edging; a base connected to the desktop computer, where the base is connected to the desktop computer with a video cable, and where the base wirelessly relays a video signal from the desktop computer to the housing; a platform at a bottom portion of the base, where the platform includes a plurality of ports to enable connection to a plurality of accessories; and a stand extending from the base, where the stand provides a rest for the housing, and where the housing is detachable from the stand for use as a tablet device.

### BACKGROUND OF THE INVENTION

1. Field of the Invention

The present invention relates to a touchscreen device for a computer that allows a user to use their desktop computer like a mobile device.

2. Description of Related Art

Home computing devices are continuously changing and evolving. Desktop computers have been a traditional home computing choice by enabling a wide range of programming and entertainment possibilities. The desktop devices commonly include a computer tower connected to a monitor, keyboard and speakers. The tower includes powerful video cards, memory storage options, and cooling systems to run the most advanced operating systems, games and programming software. The computing options are endless with the added convenience of upgrading options, essentially making the computer's longevity endless.

As technology advances and the portable devices become more affordable, many households are changing from having a desktop computer to laptops or tablet devices. Although the desktops often possess more computing power and storage capabilities than the portable, handheld devices, traditional desktops are always restricted by mobility and freedom by chaining the user to one location when in use. The portable devices are convenient because of their ability to perform in any location. The user is able to run most operating systems, surf the internet, take pictures and play games. While these devices are functionally convenient they typically do not allow for upgrading, or are able to run the highest powered processors. Therefore, it would be beneficial in the art to provide a computing device that combines the processing power of a desktop computer with the portable convenience of a tablet.

### SUMMARY OF THE INVENTION

In view of the foregoing disadvantages inherent in the prior art, the general purpose of the present invention is to provide a wireless touchscreen device for use with a desktop computer, configured to include all of the advantages of the prior art, and to overcome the drawbacks inherent therein.

Accordingly, an object of the present invention is to provide a wireless touchscreen device and base, where the base is connected to a desktop computer and transmits video signals to the wireless touchscreen device via a wireless signal.

Another object of the present invention is to provide a base connected to a desktop computer which charges a wireless touchscreen device when the touchscreen device rests upon the base.

To achieve the above objects, in an aspect of the present invention, a wireless touchscreen device is described comprising a housing, where the housing includes an edging; a touchscreen on a front face the housing, where the touchscreen is surrounded by the edging; a base connected to the desktop computer, where the base is connected to the desktop computer with a video cable, and where the base wirelessly relays a video signal from the desktop computer to the housing; a platform at a bottom portion of the base, where the platform includes a plurality of ports to enable connection to a plurality of accessories; and a stand extending from the base, where the stand provides a rest for the housing, and where the housing is detachable from the stand for use as a tablet device.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a front view of a wireless touchscreen device in accordance with an exemplary embodiment of the present invention;

FIG. 2 depicts a bottom view of a wireless touchscreen device in accordance with an exemplary embodiment of the present invention;

FIG. 3 depicts a backside of a base in accordance with an exemplary embodiment of the present invention; and

FIG. 4 depicts a side view of a base in accordance with an exemplary embodiment of the present invention.

Like reference numerals refer to like parts throughout the description of several views of the drawings.

### DETAILED DESCRIPTION OF THE DRAWINGS

The present invention relates to a touchscreen device for a computer that allows a user to use their desktop computer like a mobile device. The present invention provides a wireless touchscreen device for a desktop computer which separates the screen/video interface for desktops from the core, standard processing component of the tower, thus allowing for a portable monitor. The wireless touchscreen device may rest upon a base which incorporates a video jack capable of receiving standard video input from any desktop graphics card, subsequently transferring the data wirelessly to the tablet monitor. The screen of the device relays data back to the desktop in a similar fashion. The configuration allows a user to possess the powerful processing abilities inherent in traditional desktop computers while being afforded the mobility of a handheld gadget.

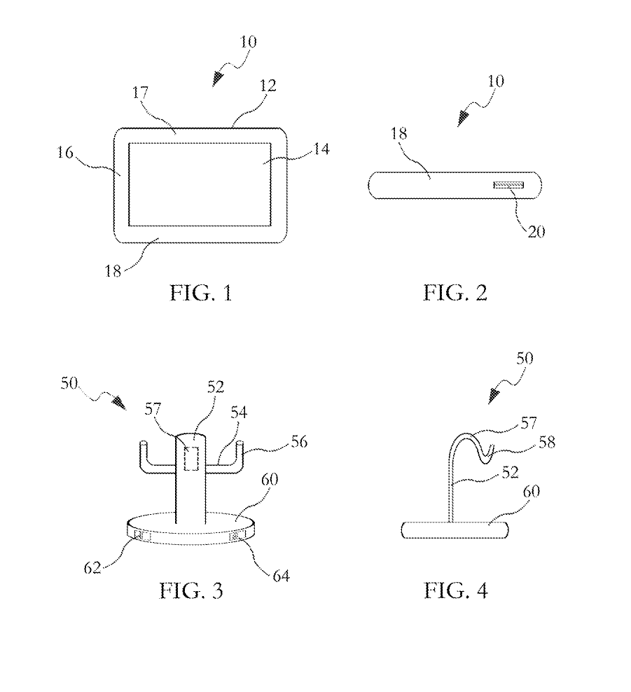

Turning now descriptively to the drawings, referring to FIG. 1, a perspective view of a wireless touchscreen device 10 is shown in accordance with an exemplary embodiment of the present invention. The wireless touchscreen device 10 comprises a rectangular housing 12. The housing 12 includes a screen 14 encompassing the entire front face of the wireless touch screen device 10. The screen 14 is a touchscreen to enable the user to operate a wireless touchscreen device 10 by simply swiping their fingers thereby maneuvering between various displays. The diagonal measurement of the screen 14 may range from 10-16 inches, preferably measuring 15 inches.

The housing 12 further includes an edging where the edging is made up of a pair of sides 16, a top edge 17 and a bottom edge 18. The user grasps the edging to hold the housing 12 so as to not inadvertently touch the screen 14. The housing 12 may be made from aluminum, plastic or another lightweight yet durable material to ensure that the wireless touchscreen device 10 is easily portable and may be carried by one hand.

Referring now to FIG. 2, the bottom edge 18 of the wireless touchscreen device 10 is shown in accordance with an exemplary embodiment of the present invention. The bottom edge 18 of the housing 12 includes a port 20. The port 20 may receive a USB cable or a charger cord. By connecting a charger cord to the port 20 the user is able to quickly and easily charge the wireless touchscreen device 10. One or more ports 20 may be positioned around the edging of the housing 12 to enable the user to connect various electronic devices to the wireless touchscreen device 10.

Referring now to FIG. 3, a backside of a base 50 is shown in accordance with an exemplary embodiment of the present invention. The base 50 includes an upright stand 52. At a middle portion of the stand 52 a pair of arms 54 are positioned, from which extend a pair of upward supports 56. The stand 52 and the pair of upward supports 56 brace the backside of the housing 12 to maintain the housing 12 in an upright position while resting on the base 50. On a front side of the stand 52 extends a device support 57 which will be explained below in reference to FIG. 4.

The base 50 is positioned upon a platform 60. The platform 60 may be circular (as shown), square or any other wide supporting shape. On a backside of the platform 60 may be one or more ports 62, 64. A first port 62 may be a power port where an electrical outlet cord is connected. A second port 64 may be a video connection port to receive a video cable from a desktop computer. Additional ports may be positioned on the platform 60 like USB, webcam, and microphone ports and audio outputs. Speakers may be built into the platform 60. Finally, a keyboard may be connected to the platform via one of the USB ports. While the housing 12 is attached to the base 50, not only will it be charging, it will transfer the data in a traditional wired manner instead of a wireless manner.

The base 50 receives a video signal from the computer through the video cable. It then transmits the video signal from the computer to the wireless touchscreen device through Bluetooth® wireless technology. This enables the wireless touchscreen device to display quality images from a high powered processor within the computer.

FIG. 4 depicts a side view of the base 50 in accordance with an exemplary embodiment of the present invention. From the stand 52 protrudes the device support 57. The device support 57 includes a lip 58 which extends upwardly from the device support 57. The lip 58 prevents the housing from sliding off the device support 57 while resting on the stand 52. The device support 57 and lip 58 allow the wireless touchscreen device to rest and charge while upon the base 50. While positioned in on the base 50, the wireless touchscreen device charges and displays the video images from the computer. The base 50 serves as a prop for the wireless touchscreen device to enable the user to manipulate the screen without requiring both hands like a touchscreen monitor.

The wireless touchscreen device may detach from the base 50 and used as a tablet device where the user only holds the housing to display the computer images. Bluetooth® wireless technology provides additional convenience by allowing the wireless touchscreen device to be controlled by the high powered processor in the computer. This way the user may enjoy programs that typically require a higher processor, storage and cooling elements than are found in tablet devices. The wireless touchscreen device is like a portable desktop monitor combining the powerful processing within a desktop computer tower with a handheld computing device.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A wireless touchscreen device for use with a desktop computer comprising:
a. a housing, where the housing includes an edging;
b. a touchscreen on a front face the housing, where the touchscreen is surrounded by the edging, where the edging enables holding the housing without touching the touchscreen;
c. a base connected to the desktop computer, where the base is connected to the desktop computer with a video cable, and where the base wirelessly relays a video signal from the desktop computer to the housing;
d. a platform at a bottom portion of the base, where the platform includes a plurality of ports to enable connection to a plurality of accessories; and
e. a stand extending from the base, where the stand provides a rest for the housing, and where the housing is detachable from the stand for use as a tablet device.

2. The wireless touchscreen device according to claim 1, where the base relays the video signal via Bluetooth® wireless technology.

3. The wireless touchscreen device according to claim 1, where the stand includes a pair of arms to support a back side of the housing while the housing rests on the stand.

4. The wireless touchscreen device according to claim 3, where the pair of arms include a pair of upward supports to maintain the housing in an upright position.

5. The wireless touchscreen device according to claim 1, where the stand includes a device support extending from a front of the stand, where the device support lifts the housing.

6. The wireless touchscreen device according to claim 5, where the device support includes a lip to prevent the housing from sliding.

7. The wireless touchscreen device according to claim 1, where the housing charges while resting on the stand.

8. The wireless touchscreen device according to claim 1, where the plurality of accessories include one of at least a microphone, webcam and keyboard.
